(19) United States
(12) Patent Application Publication
(10) Pub. No.: US 2019/0351821 A1
(43) Pub. Date: Nov. 21, 2019

(54) VEHICLE PART COMPRISING A LIGHTING SYSTEM

(71) Applicant: TOYOTA MOTOR EUROPE, Brussels (BE)

(72) Inventors: Aurelien BADOIL, Brussels (BE); Carole FAVART, Brussels (BE); Alexandre GENTNER, Brussels (BE)

(73) Assignee: TOYOTA MOTOR EUROPE, Brussels (BE)

(21) Appl. No.: 16/303,898

(22) PCT Filed: Jun. 20, 2016
(86) PCT No.: PCT/EP2016/064180

§ 371 Date: Nov. 21, 2018

(51) Int. Cl. B60Q 3/14; B60Q 3/208

(52) U.S. Cl. CPC B60Q 3/14; B60Q 3/217; B60Q 3/208

(57) ABSTRACT

A vehicle part includes a main body and a lighting system, the lighting system comprising a chamber defining a cavity having an opening which opens out onto an outside of the main body, and a light source arranged in the cavity and configured to emit light towards the opening, the vehicle part further includes a skin covering the opening and at least one area of the main body adjacent to the opening, wherein the skin is configured to let light emitted by the light source pass through when the light source is switched on.

### TECHNICAL FIELD

The invention relates to a vehicle part comprising a main body and a lighting system. More particularly, the invention is directed to an improvement in the integration of the lighting system in the vehicle part. The vehicle part may be used in an interior of an automotive vehicle.

### TECHNOLOGICAL BACKGROUND

The Japanese patent application published under the number JP 2015-039979 A describes a vehicle door opening notification lighting device arranged on an inner side of a vehicle door and configured to emit red light, so as to call attention of a passenger to a rear vehicle or a pedestrian when the passenger is opening the door. The lighting device includes a band-like light guide provided over a door inner side.

In such a lighting device, however, no provision is taken to smoothly integrate the light guide in the door, which deteriorates a visual aspect of the passenger compartment. Therefore, there is a need for a new type of vehicle part comprising a lighting system.

### SUMMARY OF THE INVENTION

In this respect, the present disclosure relates to a vehicle part comprising a main body and a lighting system, the lighting system comprising a chamber defining a cavity having an opening which opens out onto an outside of the main body, and a light source arranged in the cavity and configured to emit light towards the opening, the vehicle part further comprising a skin covering the opening and at least one area of the main body adjacent to the opening, wherein the skin is configured to let light emitted by the light source pass through when the light source is switched on.

The chamber may be embodied by a frame and/or by the shape of the main body. The frame may be integrated in the main body. Depending on the shape of the frame, the light source can be arranged inside the frame or on the frame.

The skin covers at least one area of the main body adjacent to the opening. For instance, the main body comprises a trim body outside the cavity and said adjacent area comprises at least part of an outer surface of the trim body.

Thanks to the above described structure, the skin continuously covers the opening and an area of the main body, thereby ensuring a smooth aspect of the vehicle part having a lighting system integrated therein.

In some embodiments, the lighting system is configured such that for a given incident light, intensity of the incident light which is reflected and absorbed by the skin is greater than intensity of the incident light which is transmitted by the skin towards inside the cavity, reflected in the cavity and transmitted by the skin towards outside the cavity.

When light is incident on the skin, the light can be reflected, absorbed, transmitted, or a combination thereof. “Reflected” means that the light is at least partly resent on the same side as where it came from. “Transmitted” means that the light passes through the skin and gets out on the other side than where it came from. “Absorbed” means that the light is absorbed in the material of the skin, i.e. neither transmitted nor reflected. For simplicity reasons, light which is scattered inside the skin is considered as transmitted, reflected or absorbed, depending on whether and, if applicable, where the scattered light exits the skin.

The above recited configuration of the lighting system depends in particular on a transmission coefficient of the skin, a reflection coefficient of the skin and a reflection coefficient of the material inside the cavity.

Due to the above recited configuration, when the skin is lit by an incident light, the light is mostly reflected and/or absorbed by the skin. Only a small part of the incident light is transmitted by the skin. Therefore, for an observer located on one side of the skin, e.g. outside of the cavity, the appearance of the skin depends on the relative light intensity of the light reflected on the side of the observer, and of the light emitted or reflected from the other side of the skin, e.g. inside the cavity, and transmitted to the observer through the skin.

In a first situation wherein the inside of the cavity is relatively dark, e.g. when the light source is switched off, and the outside of the main body, i.e. the vehicle passenger compartment, is relatively light, the amount of light transmitted by the skin from the inside of the cavity to the outside of the vehicle part is small as compared to the amount of light reflected (and scattered) by the skin outside the vehicle part. Thus, an observer external to the vehicle part mostly sees the light reflected by the skin and does not perceive the light coming out of the opening through the skin, whereby the skin acts as hiding the inside of the cavity.

In a second situation wherein the inside of the cavity is relatively light, e.g. when the light source is switched on, and the outside of the cavity is relatively dark as compared to the switched on light source, the amount of light transmitted by the skin from the inside of the cavity to the outside of the vehicle part is great as compared to the amount of light reflected by the skin outside the vehicle part. Thus, an observer external to the vehicle part mostly sees the light emitted by the light source and transmitted by the skin.

Therefore, the skin lets light emitted by the light source pass through when the light source is switched on and hides the light source and the cavity from the outside of the main body when the light source is switched off. This configuration further improves the look of the vehicle part and gives an additional smooth aspect when the light is off.

The skin may comprise a translucent material, a one-way mirror, a beam splitter or the like. Further examples are provided below. The material is respectively considered as translucent, one-way mirror or beam splitter at least for visible wavelengths.

When the skin comprises a translucent material, a transmission coefficient of the material for the spectrum of wavelength visible by a human eye may be chosen great enough to limit loss of energy used by the emitting light source, as long as the interior of the cavity is not visible during daylight conditions, when the light source is switched off, as explained above.

In some embodiments, a light diffuser is arranged in the cavity, between the light source and the skin. Thanks to the diffuser, the light coming from the light source is scattered, which creates a consistent a homogeneous light surface and gives the impression of a uniform spread source. In addition or as an alternative, the skin may have light diffusing properties. The combined transmission coefficient of the skin and the light diffuser may be below 60%, preferably below 50%.

In some embodiments, the light source comprises a light ribbon comprising a plurality of light emitting elements, such as light emitting diodes. Such a configuration makes easier to illuminate long surfaces. Light emitting diodes are low-consuming light sources which are easy to control.

In some embodiments, the vehicle part further comprises a window connected to the main body, and the main body comprises a shade portion arranged between the opening and the window, the shade portion intersecting an optical path of the light emitted from the opening to the window. The shade portion stops the light rays that would otherwise go directly from the opening to the window and reflect thereon. Therefore, reflections which may disturb the driver are avoided.

In some embodiments, the vehicle part further comprises a controller configured to control a light pattern emitted by the light source. A light pattern may be characterized by animation, intensity and/or color of the light emitted by the light source. Such a light pattern enables to illuminate the vehicle compartment as well as highlight portions of the surroundings for vehicle occupants.

In some embodiments, the vehicle part further comprises at least one sensor, wherein the controller is configured to control a light pattern emitted by the light source based on signals provided to the controller by the at least one sensor. The sensor may be a speed sensor, an outside-illumination sensor, an outside-object proximity detector, a door opening sensor, etc. The controller controls the light pattern in response to information collected by at least one of the sensors, so as to provide the driver with simple information.

In some embodiments, the light pattern emitted by the light source is controlled by the controller based on controller settings. For instance, the light pattern may vary according to a predetermined pattern for creating a desired atmosphere in the vehicle.

In some embodiments, said main body is a door trim. The door trim is arranged on the door, at lateral sides of the vehicle. When the main body, is a door trim, the above-mentioned window may be a side window of the vehicle.

In some embodiments, said main body is a front trim, such as an instrument panel. The front trim is arranged in front of the driver, i.e. at a front side of the vehicle. When the main body is a front trim, the above-mentioned window may be a windshield of the vehicle. The front trim may be an upper portion of an instrument panel, i.e. an upper instrument panel.

The present disclosure relates to a vehicle comprising a vehicle part as defined above.

In some embodiments, the position and/or the orientation of the opening is arranged so that the light emitted by the lighting system is located in the peripheral vision area of an average-size driver, whose head rests on a headrest of a driver's seat and whose look is focused on a windshield of the vehicle. Thus, the light emitted by the lighting system is effectively perceived by the driver, yet does not disturb the driver and does not turn his attention away from the road.

In some embodiments, the vehicle comprises a second vehicle part at least partially covered with a reflection-proof coating. The reflection-proof coating reduces or prevents light reflection thereon of the light emitted by the light source.

### BRIEF DESCRIPTION OF THE DRAWINGS

The invention and advantages thereof will be better understood upon reading the detailed description which follows, of embodiments of the invention given as non-limiting examples. This description refers to the appended drawings, wherein:

FIG. 1 is a diagrammatic section view of a vehicle part according to an embodiment;

FIG. 2 is a diagrammatic section view of a vehicle part according to another embodiment, wherein the main body is a door trim;

FIG. 3 is a diagrammatic section view of a vehicle part according to another embodiment, wherein the main body is an upper instrument panel;

FIG. 4 is a top view of a vehicle comprising a vehicle part according to an embodiment;

Fig. is a rear inner view of a vehicle comprising a vehicle part according to an embodiment;

FIG. 6 is a diagrammatic view of vision areas of human eye.

### DETAILED DESCRIPTION OF EMBODIMENTS

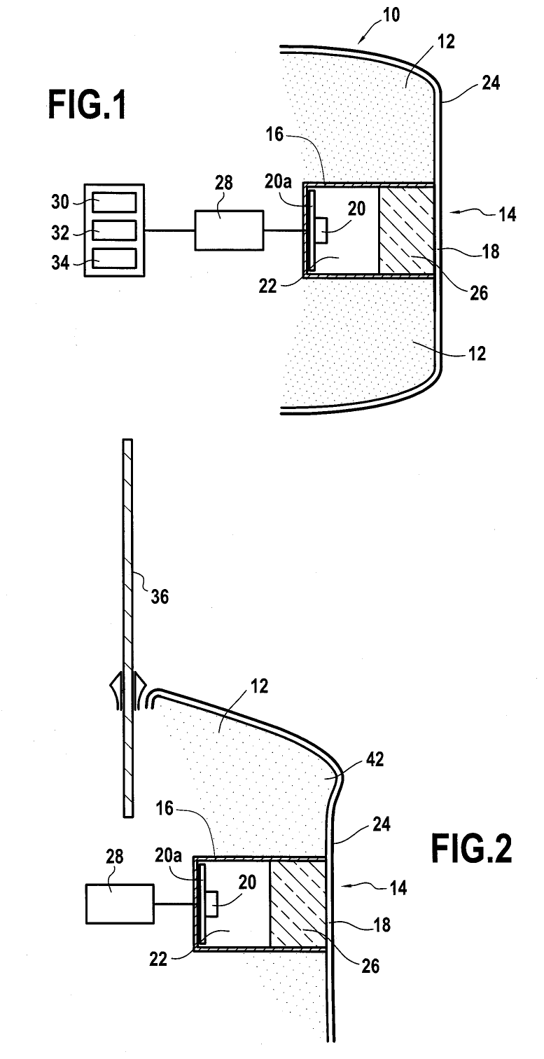

A first embodiment of a vehicle part is described with reference to FIG. 1. FIG. 1 is a diagrammatic section view of a vehicle part 10. The vehicle part 10 comprises a main body 12 and a lighting system 14. The lighting system 14 is at least partially housed in the main body 12. In the present embodiment, the lighting system 14 comprises a frame 16 integrated in the main body 12. However, the frame 16 may not be necessary, e.g. if the main body 12 has a required shape. In this embodiment, the frame 16 is arranged in a corresponding groove of the main body 12. In addition, the frame 16 is a U-shaped frame. However, other shapes are possible. The frame 16 has an opening 18 which opens out onto an outside of the main body 12. For instance, when the main body 12 is an inner trim of a vehicle, the opening 18 may open out onto a compartment of the vehicle.

The lighting system 14 comprises a light source 20 arranged in the frame 16 and configured to emit light towards the opening 18. In this embodiment, the frame 16 and/or the main body 12 act as a chamber to define, on one side of the opening 18, a cavity 22. The light source 20 is housed inside the cavity 22 and configured to emit light in the cavity 22; the light then exits the cavity 22 through the opening 18.

In this embodiment, the light source 20 comprises a light ribbon 20a comprising a plurality of light emitting elements, such as light emitting diodes (LEDs). The ribbon 20a may comprise red, green and blue LEDs. However, other suitable light sources may be chosen by the skilled person.

As previously indicated, the vehicle part 10 further comprises a skin 24. The skin 24 covers the opening 18 and areas of the main body 12 adjacent to the opening 18. Furthermore, the skin 24 is configured to let light emitted by the light source 20 pass through when the light source 20 is switched on. In other words, the skin 24 has such a material and/or a structure that light emitted by the light source 20 can pass through the opening 18, through the skin 24, towards the outside of the cavity 22 and the main body 12.

For instance, the skin 24 may comprise a translucent material, such as textile fibers, optical fibers, wood fibers, hard plastic material, e.g. polycarbonate (PC), a mix of polycarbonate and acrylonitrile butadiene styrene (PC/ABS), poly(methyl methacrylate) (PMMA) or the like, or soft plastic material, e.g. polyvinyl chloride (PVC), thermoplastic olefin (TPO) or ethylene propylene diene monomer (EPDM) or the like.

In variants, the skin 24 may comprise a one-way mirror, a beam splitter or the like.

More generally, the skin 24 may be configured such that for a given incident light, intensity of the incident light which is reflected and absorbed by the skin is greater than intensity of the incident light which is transmitted by the skin towards inside the cavity 22, reflected in the cavity 22 and transmitted again by the skin 24 towards outside the cavity 22.

Thus, not only does the skin 24 provide a smooth aspect of the vehicle part, as can be seen in FIG. 1, but it is further configured to hide the light source 20 and the frame 16 from outside the main body 12 when the light source 20 is off.

As shown in FIG. 1, a light diffuser 26 is arranged in the frame 16, between the light source 20 and the skin 24. Here, the light diffuser 26 extends from one side of the frame 16 to another, over the whole opening, so that all the light coming from the light source 20 to the opening 18 is diffused by the light diffuser 26. Thanks to the light diffuser 26, the light emitted by the light source 20 is scattered so as to create a homogenous light surface on the side of the light diffuser closest to the skin 24.

The light diffuser 26 may be made of diffusing material such as fabric, e.g. nylon, rayon or the like, foam, e.g. polyethylene (PE), polyurethane (PUR), poly(methyl methacrylate) (PMMA) or the like, polymer, e.g. natural fibers, silicone or the like, or hard plastic materials, e.g. poly(methyl methacrylate) (PMMA), Acrylonitrile butadiene styrene (ABS) or the like that may or may not be opal, prismatic, and/or crated.

The thickness of the light diffuser 26 and the distance between the light diffuser 26 and the light source 20 may be designed so as to provide a fully homogeneous light perception from the outside of the main body 12.

The skin 24 may be configured to hide the light diffuser 26 as well as the frame 16 and the light source 20 when the light source 20 is off.

As shown in FIG. 1, the vehicle part may further comprise a controller 28 configured to control a light pattern emitted by the light source 20. The controller 28 may be an electrical control unit. The controller 28 is configured to gather input information from other systems of the vehicle, interpret the input information, translate the information into a corresponding light pattern and control the light source 20 accordingly, for instance by controlling the animation, intensity and/or color of the light emitted by the light source 20. The light patterns may illuminate the vehicle compartment and/or draw the driver's attention to some portions of the surrounding environment.

In the present embodiment, the vehicle part comprises two sensors 30, 32 and a vehicle settings unit 34. The controller 28 may control the light pattern emitted by the light source 20 as a function of information transmitted by the sensors 30, 32 or, if the sensors 30, 32 do not send specific information, by the vehicle settings unit 34. The vehicle settings unit 34 may comprise information defining a default light pattern.

For instance, the controller 28 may be configured to control the light source 20 so as to emit red blinking light when a collision is detected as imminent by a collision detection sensor.

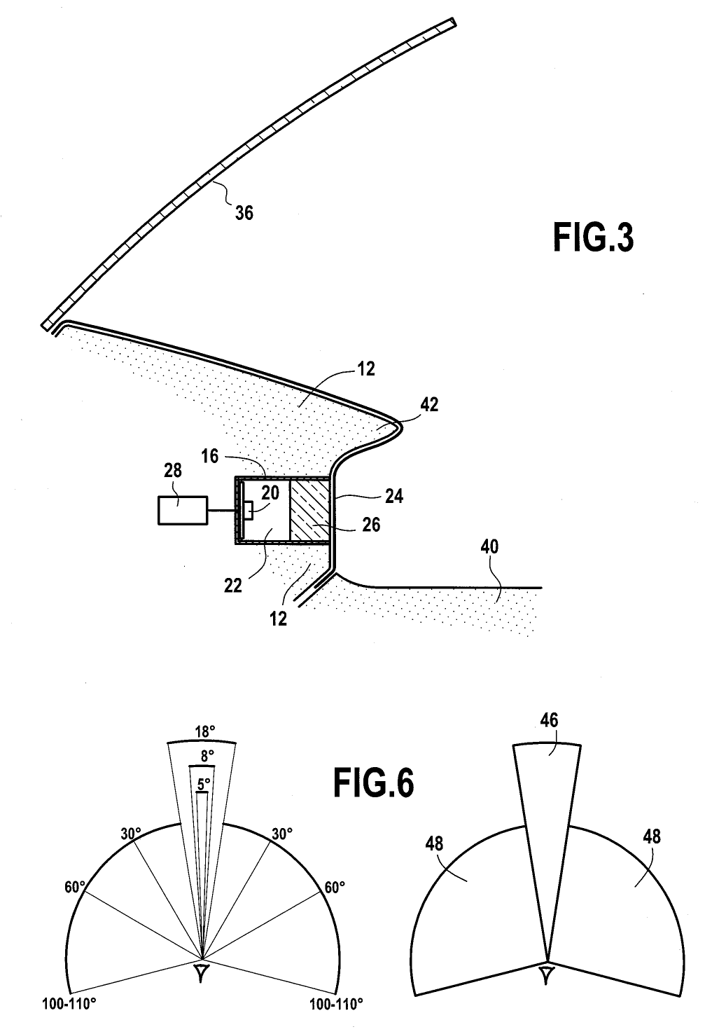

FIGS. 2 and 3 represent other embodiments of the vehicle part. In these embodiments, features similar or identical to those already described are represented with the same reference sign or omitted from the drawings, and they are not described again.

In some embodiments, such as that represented in FIG. 2, the main body 12 is a door trim. As shown in FIG. 2, in this embodiment, the vehicle part 10 further comprises a window 36 connected to the main body 12. The window 36 according to this embodiment is a side door window. The window 36 and the main body 12 may be connected directly or indirectly (e.g. through a third part), and in a fixed or non-fixed manner. In this embodiment, the window 36 may move upwards and downwards with respect to the main body 12, in a manner known per se.

As indicated above, in this embodiment, the main body 12 comprises a shade portion 42 arranged between the opening 18 and the window 36, the shade portion 42 intersecting an optical path of the light emitted from the opening 18 to the window 36. As illustrated in FIG. 2, the shade portion 42 may be a protrusion of the main body 12. The shade portion 42 may be covered by the skin 24, as shown in FIG. 2. The shade portion 42 ensures that the light emitted by the light source 20 and transmitted through the opening 18 does not reflect in the window 36, where it would bother the driver. It is noteworthy that the effect of the shade portion 42 is independent from the effect of the skin 24.

In another embodiment represented in FIG. 3, the main body 12 is a front trim. More particularly, the front trim may be an upper panel such as an instrument panel. As shown in FIG. 3, in this embodiment, the vehicle part 10 further comprises a window 36 connected to the main body 12. The window 36 according to this embodiment is a windshield. The windshield 36 and the main body 12 may be connected directly or indirectly (e.g. through a third part), and in a fixed or non-fixed manner. In this embodiment, the windshield 36 is fixed with respect to the main body 12, in a manner known per se.

In this embodiment as well, the main body 12 comprises a shade portion 42 arranged between the opening 18 and the windshield 36, the shade portion 42 intersecting an optical path of the light emitted from the opening 18 to the windshield 36. As illustrated in FIG. 3, the shade portion 42 may be a protrusion of the main body 12. The shade portion 42 may be covered by the skin 24, as shown in FIG. 3. The shade portion 42 ensures that the light emitted by the light source 20 and transmitted through the opening 18 does not reflect in the windshield 36, where it would bother the driver and/or overlap with other emitted lights such as a head-up display.

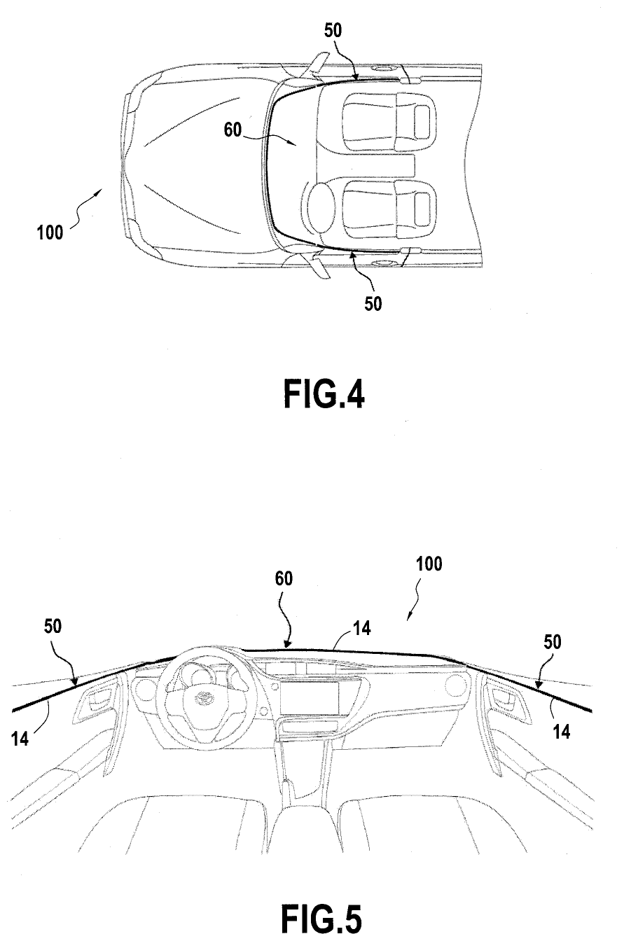

A vehicle 100 comprising a vehicle part 10 according to an embodiment is represented in FIGS. 4 and 5. The vehicle 100 comprises two lateral portions 50, e.g. left and right front doors, and a front portion 60.

The vehicle 100 comprises at least a vehicle part according to any one of the previously described embodiments. For instance, the lateral portions 50 may comprise a vehicle part whose main body is a door trim, as described in reference to FIG. 2, and/or the front portion 60 may comprise a vehicle part whose main body is a front trim, as described in reference to FIG. 3.

In the embodiment of FIGS. 4 and 5, distinct lighting systems 14 are used for the respective vehicle parts of the lateral portions 50 and of the front portions 60. However, the lighting system 14 could be common to and shared between the vehicle parts, or even several lighting systems could be used within each vehicle part.

The vehicle 100 may comprise a second vehicle part 40 (see FIG. 3). In FIG. 3, the second vehicle part 40 is illustrated as a lower panel. The second vehicle part 40 may comprise a main body and a lighting system 14 as above described, but does not have to. The second vehicle part 40 may be at least partially covered with a reflection-proof coating. For instance, a surface of the second vehicle part 40 which is directly reached by light emitted by the light source 20 through the opening 18 may be covered with a reflection-proof coating. In this disclosure, “reach directly” means that light coming out of the opening 18 reaches the surface without being reflected. Of course, other surfaces of the second vehicle part 40 may be covered with said coating as well. If at least the surface of the second vehicle part 40 which is directly reached by light emitted by the light source 20 is covered with a reflection-proof coating, direct reflections of said light, which may then reflect on a window and/or disturb the driver, are avoided. Thus, it is ensured that the shade portion 42 is not by-passed by reflected light.

Back to FIG. 5, the lighting system 14 is arranged within the vehicle part and the vehicle part is arranged within the vehicle 100 so that the position and/or the orientation of the opening 18 is such that the light emitted by the lighting system 14 is located in the peripheral vision area 48 of an average-size driver, whose head rests on a headrest of a driver's seat and whose look is focused on a windshield of the vehicle 100.

With reference to FIG. 6, the field of view of human eye is classically divided in coaxial conical volumes of which the eye is the apex. In the following description, a conical volume is defined by its half top angle, i.e. the angle between an axis of the cone and a generatrix of the cone. The axis of the cone is the direction in which the eye is focused. The angle values given below are given with a margin of ±10%.

A conical volume of 5° (i.e. a conical volume of which the eye is the apex, the axis is the direction in which the eye is focused and the generatrix forms an angle of 5° with the axis) is referred to as a central region. A conical volume between 5° and 8° is referred to as a paracentral region and a conical volume between 8° and 18° is referred to as a macular region. The central, paracentral and macular regions form together a conical volume of 18° called focused vision area 46, where the eye accurately perceives movements, shapes and colors. For a driver, the focused vision area 46 is intended to be focused on road and driving conditions.

A conical volume between 18° and 30° is referred to as a near peripheral region. A conical volume between 30° and 60° is referred to as a mid-peripheral region. A conical volume between 60° and 100°-110° is referred to as a far peripheral region. Together, the near, mid and far peripheral regions form a conical volume between 18° and 100°-110° called peripheral vision area 48, where the look is not focused but movements, shapes and colors can still be perceived.

When a vehicle such as a car is designed, the various elements are arranged by taking into account the position of a seated average-size driver, whose head rests on a headrest of a driver's seat and whose look is focused on a windshield of the vehicle, i.e. virtually focused on the road in front of the vehicle. Therefore, the position of a seated average-size driver is well-defined in a vehicle and determined by the sub-assemblies of the vehicle itself.

Positioning and/or orienting the lighting system 14 so that the light emitted by the lighting system 14 is located in the peripheral vision area 48 of an average-size driver ensures an intuitive understanding of the emitted lighting signal without disruption or cognitive overload of the driver.

The position and/or orientation of the lighting system 14 may also be designed in accordance with the position of the vehicle windows, in order to further avoid undesired reflections that could disturb lighting message.

Although the present invention has been described by referring to specific exemplary embodiments, modifications may be provided to these examples without the departing from the general scope of the invention as defined by the claims. In particular, individual characteristics of the different illustrated/mentioned embodiments may be combined in additional embodiments. Therefore, the description and the drawings should be considered in an illustrative rather than in a restrictive sense.

1. A vehicle part comprising a main body and a lighting system, the lighting system comprising a chamber defining a cavity having an opening which opens out onto an outside of the main body, and a light source arranged in the cavity and configured to emit light towards the opening, the vehicle part further comprising a skin covering the opening and at least one area of the main body adjacent to the opening, wherein the skin is configured to let light emitted by the light source pass through when the light source is switched on.

2. The vehicle part as claimed in claim 1, wherein the lighting system is configured such that for a given incident light, intensity of the incident light which is reflected and absorbed by the skin is greater than intensity of the incident light which is transmitted by the skin towards inside the cavity, reflected in the cavity and transmitted by the skin towards outside the cavity.

3. The vehicle part as claimed in claim 1, wherein the skin comprises a translucent material.

4. The vehicle part as claimed in claim 1, wherein a light diffuser is arranged in the cavity, between the light source and the skin.

5. The vehicle part as claimed in claim 1, wherein the light source comprises a light ribbon comprising a plurality of light emitting elements, such as light emitting diodes.

6. The vehicle part as claimed in claim 1, further comprising a window connected to the main body, and wherein the main body comprises a shade portion arranged between the opening and the window, the shade portion intersecting an optical path of the light emitted from the opening to the window.

7. The vehicle part as claimed in claim 1, further comprising a controller configured to control a light pattern emitted by the light source.

8. The vehicle part as claimed in claim 7, further comprising at least one sensor, wherein the controller is configured to control a light pattern emitted by the light source based on signals provided to the controller by the at least one sensor.

9. The vehicle part as claimed in claim 7, wherein the light pattern emitted by the light source is controlled by the controller based on controller settings.

10. The vehicle part as claimed in claim 1, wherein the main body is a door trim.

11. The vehicle part as claimed in claim 1, wherein the main body is a front trim.

12. A vehicle comprising a vehicle part as claimed in claim 1.

13. The vehicle as claimed in claim 12, wherein the position and/or the orientation of the opening is arranged so that the light emitted by the lighting system is located in the peripheral vision area of an average-size driver, whose head rests on a headrest of a driver's seat and whose look is focused on a windshield of the vehicle.

14. The vehicle as claimed in claim 12, further comprising a second vehicle part at least partially covered with a reflection-proof coating.

15. The vehicle part as claimed in claim 1, wherein the main body is an instrument panel.
